(19) United States
(12) Patent Application Publication
(10) Pub. No.: US 2006/0104479 A1
(43) Pub. Date: May 18, 2006

(54) Methods of unattended detection of operator's deliberate or unintentional breaches of the operating procedure and devices therefore.

(75) Inventors: ALEXANDER BONCH-OSMOLOVSKIY, Moscow (RU); IGOR FALOMKIN, Dubna (RU); GERMAN ZHYVOTNIKOV, Moscow (RU); ILYA BOGDANOV, Moscow (RU); ARTEM ORLOV, Moscow (RU)

Correspondence Address: ISS TECHNOLOGY, 102-77, VL.1, MSU SCIENCE PARK, LENINSKY GORY, MOSCOW, 119899, RU

(73) Assignee: ISS TECHNOLOGY, MOSCOW (RU)

(21) Appl. No.: 10/907,060

(22) Filed: Mar. 18, 2005

(30) Foreign Application Priority Data
Nov. 12, 2004 (RU) 2004132941

(51) Int. Cl. G06K 9/00; G06F 19/00

(52) U.S. Cl. 382/103; 382/107; 700/108

(57) ABSTRACT

Method and device is proposed herein for unattended detection of deliberate or unintentional breaches caused by an operator of a routinely executed procedure comprising transference of objects and their mandatory presenting to the item-sensing device for registration or testing or classification. The invention can be used for detecting fraud of a cashier in checkout retail environments by omitting registration of items placed on the take-away belt. The invention is based on detecting motion and presence events in the predetermined workspace areas and comparing their temporal sequence with the predetermined scenarios. In the case of coincidence with the scenario, the sensing device signal in the due time is checked to be received. In the case of a wrong or no signal received, the procedure is recognized as incorrectly executed. Motion and presence events are detected by computer analysis of live video from the camera and/or by applying the motion and the presence detectors.

### BACKGROUND OF THE INVENTION

The present invention relates generally to machine vision systems and particularly to analysis of images obtained from an optical device or a signal analysis from a set of presence and/or motion sensors or the like.

The invention relates to a sphere of unattended detection of mostly deliberate or unintentional breaches (caused by a human operator or a substituting device thereof) of a routinely executed procedure performance consisting of an item transference with one or two hands, assembling on option the item with another item, and further mandatory presenting of the resultant item to an item sensing unit for identification and/or testing thereof. The Procedures of this kind are common, for example, in item assembly or registration processes or technical and/or quality control. They share a common trait that an operator should take an item by hand from one working area (the “input” storage device 1), then, on option, assemble it with another item taken by the other hand from another working area (the “input” storage device 2), present the resultant item to a sensing unit, and, place said resultant item in one of the “output” storage devices depending on an accepted signal type from said sensing unit. Revealed breaches of the procedure execution order may consist of item transference from “input” storage devices to “output” storage devices without presenting thereof to an identification sensor or transference of the item to the other “output” storage device than required by the identification sensor signal type.

Examples of the like procedure are (a) testing produced electrical bulbs by a quality control operator, (b) assembling two-parts items by a conveyer worker and testing them by testing means with further transference of said items to one of the storage devices for good (passed) or defective (rejected) items, or (c) registration of purchased goods by a Point-of-Sale terminal (POS-terminal) cashier (checker) at a point of a retail sale and their further transference to the storage and/or bagging area.

One of possible embodiments of the invention may be unattended detection of a cashier's fraudulent activities at a point of a (retail) sale in a supermarket or the like, comprising theft of items in agreement with a customer by passing goods to the bagging area without their due identification and registration by means of the product registration device (a bar code reader).

One method known from the prior art concerns object identification via video image analysis (U.S. Pat. No. 6,678,413 Jan. 13, 2004 Liang et al.).

Another known method describes the way to determine an object orientation by comparing data obtained from more than one sensor (U.S. Pat. No. 6,710,719 Mar. 23, 2004 Jone et al.). According to the method video sensors are mounted at different directions from the object. The object orientation is found as a result of analysis of the obtained images therefrom.

Another known method deals with spotting of an object in the image (U.S. Pat. No. 6,636,635 Oct. 21, 2003 Matsugu).

Another known method concerns the way to predict the desired user function based on the user behavior history. (U.S. Pat. No. 6,400,996 Jun. 4, 2002 Hoffberg et al.)

Another known method relates to recognition of hand gestures by analyzing pairs of images generated by video cameras arranged in a stereo system (U.S. Pat. No. 6,215,890 Apr. 10, 2001 Matsuo et al.).

Some of known methods and tools of image and video analysis used in the abovementioned inventions might be close to certain methods realized in the present invention but the problems addressed in the art are basically different from that solved herein.

A device and methods also known in the art relate to prevention of a fraud in retail environment via monitoring the shopping cart to control emptiness thereof (U.S. Pat. No. 5,883,968 Mar. 16, 1999 Welch et al.).

The criterion of process termination used in the above mentioned invention is too ambiguous. Therefore, the obtained conclusions may be incorrect.

The latter invention is taken as the closest prior art.

All mentioned methods fail to solve the problem of the present invention—to detect deliberate or unintentional (or inadvertent) breaches (by a human operator or a substituting device thereof) of a routinely executed procedure.

The technical result of the present invention lies in the revelation of breaches of the procedure caused by a human operator (or a substituting device thereof) at the preliminarily defined level of false alarms and with relatively low hardware resource requirements.

All known methods and devices fail to achieve the declared technical result.

### SUMMARY OF THE INVENTION

The declared technical result as a method may be attained in a variety of ways each comprising preliminary steps and steps performed during the actual monitoring process.

Preliminary steps comprise the following.

An Operator's typical hands/arms and/or item movements and/or paths thereof occurring during the procedure correct execution are recognized. The procedure is divided into several component phases, each phase characterized by movement and/or presence of an operator's hands and/or items in certain areas of the working space or absence thereof in said certain areas. The area where an item is presented to the identification sensor is considered as an area of presence.

Some or all of said areas are then assigned for monitoring. Said monitoring is performed in the image, if a video system is used according to the first version of the method, and directly in the working space, otherwise (if other than video means is used) according to the second version of the method. One or more scenarios of one or more variants of the correct procedure execution are formed as the order of the events of presence and/or movement of objects, that is an operator's hands/arms and/or items and the due time breaks (delays) separating the motion and/or the presence events or a lack thereof that must be observable (or registered) in said assigned areas. Said scenario may also specify the due moment in the sequence of said events when a signal is to be received from the item identification sensor during the correct execution of the procedure and a type of said signal, if applicable.

The actual monitoring of the procedure comprises the following steps.

Object motion and/or presence in one or more areas assigned for monitoring is detected. When a video system is used according to the first version of the method, said detection is performed by means of color and/or brightness and temporal analysis of video data, said analysis being performed via comparing consecutive (or interrupted) video frames by any means known in the art. Signals from any supplementary sensors can also be used to increase the results reliability. According to the second version of the method if no video system is used said detection is performed by motion and/or presence detection means.

The declared technical result in detection of deliberate or unintentional breaches caused by a human operator or a substituting device thereof according to the first version is provided by a device that monitors said operator's activity in the working space and interactions thereof with an item sensing unit; said monitoring device comprising a computing device (on the base of a computer), a video camera, a device with ability to capture images from a video stream, and a coupling device adjusting said video camera and said sensing unit to said computing device. The coupling device may be realized on the base of an analog-digital converter (ADC). A list of functions realized by the coupling device comprises I/O format conversion and providing a single-image “capture” function—ability of single image extraction from a live TV signal.

The declared technical result in detection of deliberate or unintentional breaches caused by a human operator or a substituting device thereof according to the second version is provided by a device that monitors said operator's activity in the working space and interactions thereof with an item sensing unit; said monitoring device comprising a computing device (on the base of a computer), at least one presence sensor and/or at least one motion sensor, and a coupling device adjusting said sensors to the computing device. The coupling device may be realized on the base of an analog-digital converter (ADC). The coupling device realizes I/O format conversion.

The declared technical result in detection of deliberate or unintentional breaches caused by a human operator (a cashier at a point of sale or the like) according to the third version is provided by a device that monitors said operator's (cashier's) activity in the working space and interactions thereof with an item sensing unit (a bar-code reader), said monitoring device comprising a computing device (on the base of a computer), a video camera, a device to capture images from a video stream, and a coupling device adjusting said video camera and said sensing unit with said computing device. The coupling device may be realized on the base of an ADC. A list of functions realized by the coupling device comprises I/O format conversion and providing a single-image “capture” function—ability of a single image extraction from a live TV signal.

To increase reliability, the system may be furnished with one or more supplementary sensors of any type.

### BRIEF DESCRIPTION OF THE DRAWINGS

FIG. 1A gives an overhead view of typical motions of an operator's (a cashier's) hands and/or items during the procedure execution (purchase registration process) as depicted in the images taken by a video camera.

FIG. 1B gives an overhead view of typical motions of an operator's (a cashier's) hands and/or items and areas (4) monitored by motion sensors (8) and a checkout area (4a) monitored by a presence sensor (9).

FIG. 2A illustrates the first version of a device that uses a video camera and implements the first version of the claimed method.

FIG. 2B illustrates the second version of a device that uses motion and presence sensors and implements the second version of the claimed method.

FIG. 3A shows a block diagram of a device incorporating a video camera.

FIG. 3B shows a block diagram of a device incorporating motion (8) and presence (9) sensors.

FIG. 4 shows a flow diagram illustrating claimed methods.

### DETAILED DESCRIPTION OF THE INVENTION

For the purpose of illustrating the invention, the currently preferred embodiment is described, it being understood, however, that the invention is not limited to the specific methods and instrumentalities disclosed.

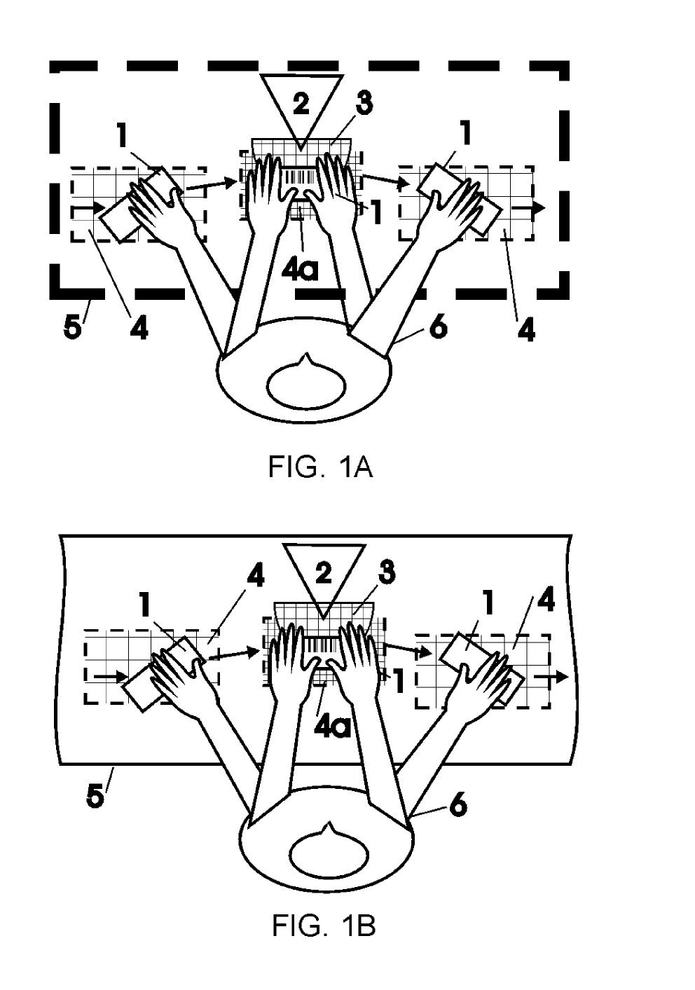

The essence of the invention is illustrated in FIG. 1-4. The case of retail environment is considered as the currently preferred embodiment.

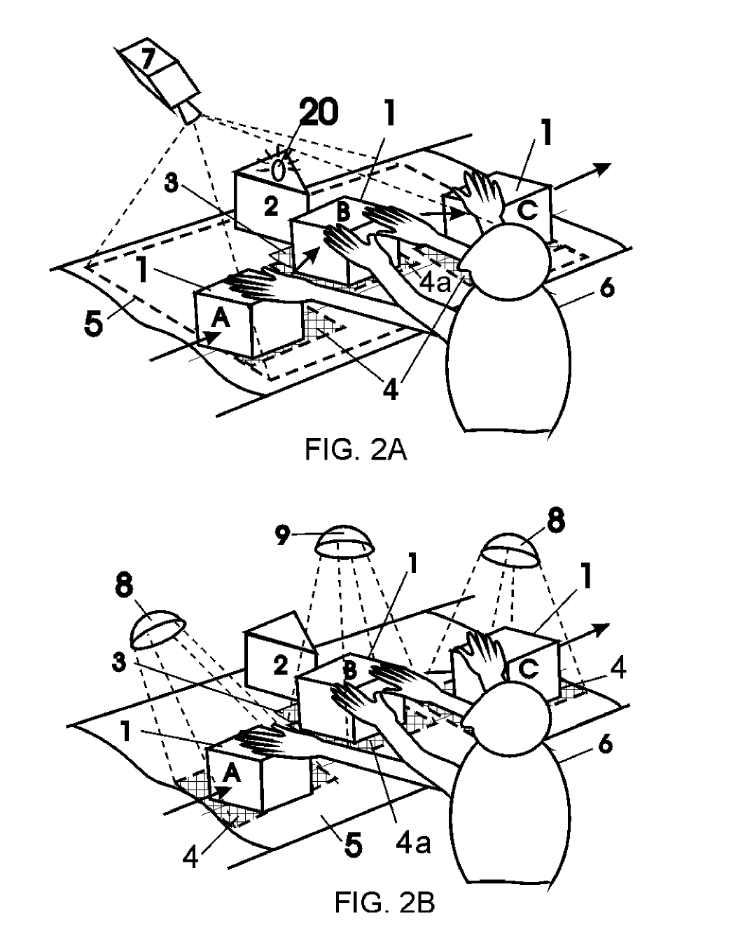

The detection of a cashier's departure from the correct procedure of purchased item registration (presumed fraud) according to the first version of the method and the first version of the device therefore is illustrated in FIG. 1A and FIG. 2A.

An item (1) is directed by a cashier (6) from an item input area (A) (a feed belt) to an item registration area (B) (a barcode reading area) and finally to a purchased item checkout area (C) (a take-away belt).

A Video camera (7) is positioned so as to view the working space (5) of a cashier (6) item transfer paths including. The Areas to be monitored for motion (4) and/or presence (4a) of the cashier's hands and/or items are preliminarily assigned. The simultaneous motion of hands by paths A→B (the left hand moves an item to the barcode reader) and C→B (the right hand moves towards the left hand to take the item) comprises a typical scenario. At the moment the item reaches the area (4a) a signal from the barcode reader (2) is expected to be received within the predetermined delay specified in said scenario. This signal may be duplicated by a light indicator (20) viewed by the video camera (7). If (i) the sequence of motion and presence events detected in the assigned areas (4) and (4a) by analyzing a stream of video frames from the camera (7) is found to match at least one said scenario and (ii) no signal from the barcode reader is received in the due time specified in said scenario, the whole transaction is considered suspicious (presumed fraudulent) and the corresponding alert signal on option is fired or recorded by a computer.

The detection of a cashier's fraud according to the second version of the method and the second version of the device therefore is illustrated in FIG. 1B and FIG. 2B. An item (1) is moved by a cashier (6) from an item input area (A) (a feed belt) to an item identification area (B) (a barcode reading area) and finally to a purchased item checkout area (C) (a take-away belt).

Areas to be monitored for motion (4) and/or presence (4a) of a cashier's hand(s) and/or item(s) are preliminarily assigned. Motion and presence events in the assigned areas (4) and (4a) are detected by motion (8) and presence (9) sensors, respectively. The simultaneous movement of hands along paths A→B (the left hand moving an item towards the barcode reader) and C→B (the right hand moving in to take the item from the left hand) comprises the typical scenario. At the moment the left hand reaches the area (4a) a signal from the barcode reader (2) is expected within the predetermined delay specified in the scenario. The signal from a sensor (2) may be of various types. Said signal may be duplicated by a light indicator (20) or a sound indicator. If (i) the sequence of motion and presence events detected in the assigned areas (4) and (4a) is found to match a scenario and (ii) no signal from the barcode reader (2) is received in the due time specified in the scenario, the whole transaction is considered suspicious (presumed fraudulent) and the corresponding alert signal on option is fired or recorded by the computer.

A method for unattended detection of an operator's (cashier's) fraud at a point of sale according to the first version uses a video stream of images of a cashier's workspace and activity plus signals from an item identification unit (for purchase registration).

Said first version of the method comprises preliminarily analysis of a cashier's typical activity, said analysis including recognizing typical movement patterns of the cashier's hands and the handled items directed from an input area (a feed belt) to an identification area (a barcode reader) and further to an output area (a take-away belt or a bagging area). The process of item transference and identification is captured from a stream of images generated by a video camera and sent to a computer. Areas to be monitored for motion and/or presence of the cashier's hands or the handled items are preliminarily assigned in the image. One or more scenarios of one or more variants of the correct procedure execution are formed as an order of events of said motion and/or presence and the due delays separating motion and/or presence events or a lack thereof that are to be observed in said assigned areas. Each scenario also specifies the moment (or the due time span) in said sequence of events when a signal from the item identification sensor is expected to be received.

The following steps are performed during the actual monitoring process. Motion and/or presence of a cashier's hands or items in one or more areas assigned for monitoring is detected by means of color and/or brightness and temporal analysis of video data, said analysis being performed by comparing consecutive or interrupted video frames using any method known. The sequence of the detected motion and/or presence events and the delays therebetween are then compared to match a scenario. Once a correspondence with at least one scenario is found, a signal from the identification sensor is expected to be received in the due time as prescribed by said scenario. If no registration signal was obtained, the whole item identification procedure is considered as incorrectly performed by the cashier and a fraud alert signal on option is issued or recorded by the computer.

A method for unattended detection of an operator's (cashier's) fraud at a point of sale according to the second version uses signals from motion and/or presence sensors of any type, said sensors collecting data from the assigned areas of the cashier's workspace and signals from an item identification unit (for purchase registration).

Said second version of the method comprises preliminarily analysis of a cashier's typical activity including typical movement patterns recognition of the cashier's hands and the handled items directed by the cashier from an input area (a feed belt) to an identification area (a barcode reader area and further to an output area (a take-away belt or a bagging area). The process of the item transference and registration is recognized as a sequence of signals collected by said motion and/or presence sensors. Areas to be monitored for movement or presence of the cashier's hands or the handled items are assigned in the image. One or more scenarios of the correct procedure execution are formed in terms of said events order and the due delays separating motion and/or presence events or a lack thereof that are to be observed in said assigned areas. Each scenario also specifies the moment or the due time delay in the sequence of said events when the signal from the item identification unit is expected to be received.

The following steps are performed during the actual monitoring process. Motion and/or presence events of a cashier's hands or items in one or more areas of the cashier's workspace assigned for monitoring are detected by means of motion and presence sensors. The sequence of motion and/or presence events and the delays therebetween detected in said areas are compared to match said the scenarios. Once a correspondence with at least one scenario is found, a signal from the identification sensor is expected to be received in the due time prescribed by said scenario. If no registration signal was obtained as due, the item identification procedure is considered incorrectly performed by the cashier and a fraud alert signal on option is issued or recorded by the computer.

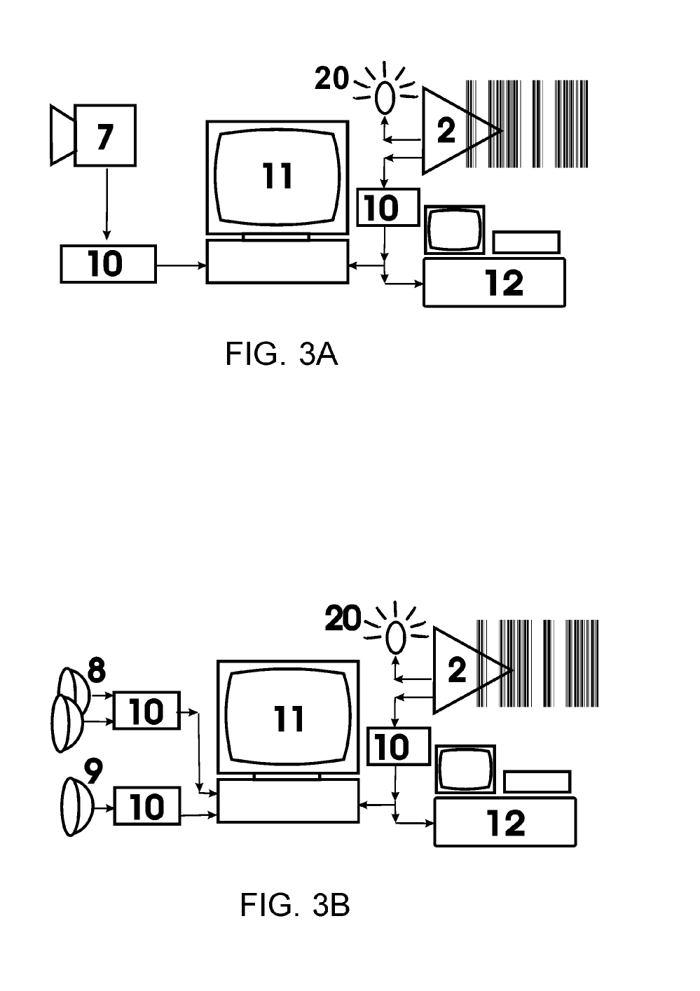

The version of the device incorporating video means is shown in FIG. 3A. A device for detecting a cashier's fraud at a point of sale in a supermarket or the like uses a video camera (7) to monitor cashier's activity and a sensor (2) for item identification. The device comprises computing means (11) (commonly, a computer running fraud-detection software), a sensor (2) for item identification (commonly, a barcode reader), the video camera (7) positioned so as to capture the image of the cashier's workspace including the item identification area, converting means (10) to convert video data and said sensor data to the format compatible with said computing device (11), and POS-Terminal (12) for purchase registration.

The Video camera (7) and the item identification sensor (2) are connected with the computing device (11) via the converters (10) to provide input-output data compatibility. The assigned areas are monitored for motion (8) and presence (9) of the cashier's hands and/or the handled items via video stream analysis. The item identification sensor (2) may be supplied by a light indicator (20) signaling purchase registration.

The version of the device incorporating other then video means is shown in FIG. 3B. The device for detecting a cashier's fraud at a point of sale in a supermarket or the like uses means able to monitor a cashier's activity via detection of the cashier's hands and/or items motion (8) and/or presence (9) in the preliminarily assigned areas. The device comprises computing means (11) (commonly, a computer running fraud-detection software), an identification sensor (2) for item identification (commonly a barcode reader), one or more motion sensors (8) positioned to detect an object's (hands and/or items) motion in the areas assigned for motion detection, one or more presence sensors (9) positioned to detect an object's (hands and/or items) presence in the areas assigned for presence detection, a POS-Terminal (12) for a purchase registration. The motion (8) and the presence (9) sensors and the item identification sensor (2) are connected with the computing device (11) via converters (10) to provide input-output data compatibility. Object motion and presence events are detected in the preliminarily assigned areas. The Item identification sensor (2) may be supplied with a light indicator (20) signaling purchase registration.

Both versions of the device may use a sound indicator signaling purchase registration. The corresponding sound sensor should be added to the device in that case.

FIG. 2A shows the first version of the claimed device. A Video camera (7) is positioned so as to capture the cashier's activity relating motion and registration of purchased items. Detecting motion of an object (the cashier hands and/or the handled items) in preliminarily assigned areas (4) on steps (A) and (C) and presence in the preliminarily assigned area (4a) on step (B) with no signal obtained from an item identification sensor (2) in step (B) is recognized as sufficient evidence to suspect the cashier's fraud.

FIG. 2B shows the second version of the principal embodiment of the claimed device. The Motion detection sensors (8) are placed to monitor preliminarily assigned areas (4). Presence detection sensor (9) is placed to monitor preliminarily assigned area (4a).

FIG. 3A shows a block diagram of the claimed device equipped with a video camera. The device operates in the following way.

Video data from the video camera (7) is converted into a stream of frames by a converting device (10) and sent to a computer (11) for processing. A signal from an item registration sensor (2) (e.g., a barcode reader) is sent to the computer (11) and to the POS-terminal (12) for the item identification and the purchase registration. The signal of an item identification device (2) may be duplicated by a light indicator (20) placed in the field of view of the video camera (7).

FIG. 3B shows a logic diagram of the claimed device using motion and presence sensors.

Signals from motion (8) and presence (9) sensors converted by a converting device (10) are sent to a computer (11). A signal from a sensing device (2) (e.g., a barcode reader) is received both by the computer (11) and the POS-terminal (12) for the item identification, and the purchase registration. The signal of the sensor (2) may be duplicated by a light indicator (20).

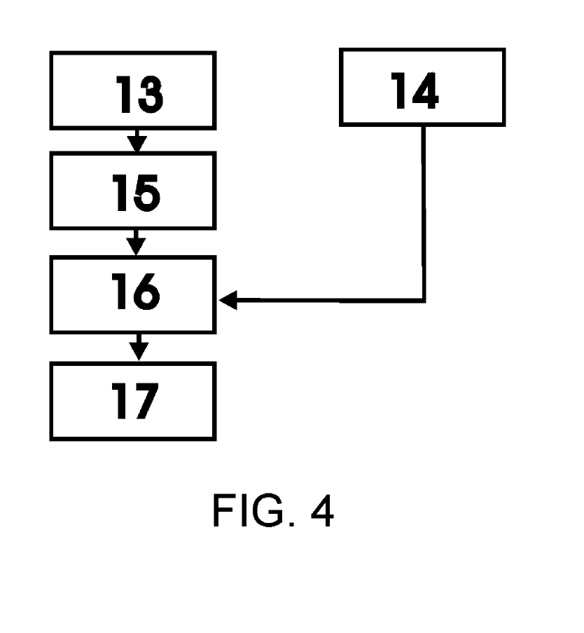

FIG. 4 is a flowchart illustrating the claimed methods.

Signals (13) indicating motion and presence events in the assigned areas (4) and (4a) are generated via analyzing frames of the video stream coming from a video camera (7), if video means is used. Otherwise, signals (13) indicating motion and presence events in the assigned areas (4) and (4a) are generated by motion (8) and/or presence (9) sensors. Said signals are arranged in sequences and stored in the computer memory in a temporal order (15). Further, said signal sequences are compared with one or more preliminarily assigned scenarios (16) assumed to correspond with the correct procedure execution (e.g., a purchase registration). Once a temporal sequence of said signals is found to match at least one said scenario, the corresponding signal (14) from the registration sensor (2) is expected to be received in the due time as indicated in said scenario. If no said signal is received as due the current transaction (17) is assumed as incorrect or fraudulent.

What is claimed is:

1. A method of unattended detection of an operator's breach of items registration, testing, or assembly procedure performance, said procedure comprising taking one or more items, from at least one item source area, on option combining said items, presenting the resultant item to an item sensing device, and further placing said item in the item destination area in accordance with said item sensing device signal type, said method comprising
motion detection signals, generated by motion detection means,
presence detection signals, generated by presence detection means,
signals generated by the item sensing device assigned for identification or testing of said items with further registration or classification on option;
further comprising the following preliminary steps:
recognizing an operator's typical hands/arms and/or an item motions and/or paths thereof occurring during the correct execution of the procedure;
assigning at least one area to be monitored for presence and/or motion of an operator's hands and/or items;
expressing temporal sequences of said typical motions and paths of the operator's hands and/or the handled items during the procedure execution in the form of at least one scenario describing a temporal sequence of said motion events in at least one area monitored for motion of the operator's hands and/or items and/or presence events in at least one area monitored for presence thereof;
performing actual monitoring of said at least one area;
assigning at least one phase in each scenario, to be accompanied by the definite signal of said item sensing device;
further comprising the following steps during the actual procedure performance:
motion of an operator's hands and/or items is monitored in at least one area assigned therefore via signals of motion detection means;
presence of an operator's hands and/or items is monitored in at least one area assigned therefore via signals of presence detection means;
a sequence of the detected events and their temporal correlation is examined for compliance with at least one scenario;
once a compliance with at least one scenario is found, the preliminarily assigned signal from said item sensing device is expected to be received in the due time according to said scenario;
once no said signal is obtained from said item sensing device, the executed procedure is regarded as incorrect.

2. The method as recited in claim 1, wherein signals related to motion detection and/or presence detection are obtained by means of a video device.

3. The method as recited in claim 2, wherein motion and/or presence of an operator's hand or a handling device of machine and/or an item in at least one monitored area is detected on the basis of color and/or brightness and temporal analysis of at least two video images.

4. The method as recited in claim 1, wherein the operator is a cashier at a retail point of sale or the like, said item sensing device is a purchase registration means, said destination area is a paid item issue area, and the operator's hands are a cahier's hands.

5. The method as recited in claim 1, further comprising examination of signal type obtained from said item sensing device.

6. The method as recited in claim 5, wherein if the signal type differs from the predetermined one, the executed procedure is regarded as a breach of the correct procedure.

7. A device for unattended detection of an operator's breach of the procedure of items registration, testing, or assembly comprising
at least one motion detection device and/or
at least one presence detection device,
an item sensing device assigned for identification or testing presented items with the further registration and/or classification on option;
at least one computing device,
at least one converting device for converting data from said detection and sensing devices to the format compatible with said computing device,
said sensing devices are connected to said computing device via said at least one converting device.

8. The device as recited in claim 7 where motion detection and/or presence detection devices are realized on the basis of video devices.

9. The device as recited in claim 7 where the operator is a cashier, said item sensing device is a purchase registration device, aid destination area is a paid item issue area, and the operator's hands are a cashier's hands.

10. The device as recited in claim 7, further comprising a light indicator of purchase registration.

11. The device as recited in claim 7, further comprising a sound indicator for indicating purchase registration and a sound-receiving device.
